(19) United States
(12) Patent Application Publication
(10) Pub. No.: US 2013/0033700 A1
(43) Pub. Date: Feb. 7, 2013

(54) RADIATION DOSIMETER WITH LOCALIZATION MEANS AND METHODS

(71) Applicant: Abdelbasset Hallil, Ottawa (CA)

(72) Inventor: Abdelbasset Hallil, Ottawa (CA)

(21) Appl. No.: 13/204,320

(22) Filed: Aug. 5, 2011

(51) Int. Cl. G01T 7/00; G01B 11/14; G01N 23/04

(52) U.S. Cl. 356/72; 378/63

(57) ABSTRACT

A apparatus for accurately measuring radiation beams during treatment which comprises a dosimeter which is used to measure the radiation; an optical marker which is used to determine the patient position; and said dosimeter and said optical marker are connected to one another used to provide and display simultaneously a radiation dose reading and a measurement of the patient's movements during treatment.

### CROSS REFERENCE TO RELATED APPLICATION

N/A

### FIELD OF THE INVENTION

The invention generally relates a dosimeter associated with an optical localization device to allow simultaneous dose and position measurement during radiotherapy procedures.

### BACKGROUND

An optical tracking system typically consists of three subsystems. The three major components consist of an optical imaging system, a mechanical tracking platform and a tracking computer. The optical imaging system is responsible for converting the light from the target area into digital image that the tracking computer can process. Depending on the design of the optical tracking system, the optical imaging system can vary from as simple as a standard digital camera to as specialized as an astronomical telescope on the top of a mountain. The specification of the optical imaging system determines the upper-limit of the effective range of the tracking system.

Most optical tracking devices currently used in virtual environments are for tracking head position and orientation. The optoelectronic ceiling tracker developed at the University of North Carolina is an example of a head tracker. The system consists of three cameras mounted on the HMD (Human Made Device), and 1000 infrared LEDs placed uniformly across the ceiling. The computer pulses the LEDs sequentially and processes the images to detect the flashes. Based on the locations of the flashes, the position and orientation of the head are calculated. The range of the optoelectronic ceiling tracker is limited only by the area of the ceiling covered by LEDs, and is thus easily expandable.

Four infrared LEDs, arranged in a prescribed pattern on the HMD, are monitored by a camera mounted at a fixed position in the environment. As with the UNC system, the LEDs are pulsed one at a time, and the positions of the resulting flashes on the camera images together with the known relations between the LEDs are used to compute the position and orientation of the head.

Optical trackers in general have high update rates, and sufficiently short lags. However, they suffer from the line of sight problem, in that any obstacle between sensor and source seriously degrades the tracker's performance. Ambient light and infrared radiation also adversely affect optical tracker performance. As a result, the environment must be carefully designed to eliminate as much as possible these causes of uncertainty. The software that runs such systems must be customized for the corresponding hardware components. Thereafter, the optical trackers started be used for medical procedure.

Traditionally, optically guided radiation therapy systems have played an important role in improving the precision of patient treatment. The tracking system will allow the medical person to precisely position the internal targets relatives to the isocenter of a treatment machine and also allow one to track patients in real time. By tracking the patient, this allows medical providers to reduce dose to healthy areas by imaging and contouring, and therefore allow one to limit the amount of normal tissue included in the irradiation volume.

The optical tracking systems have recently been incorporated into fractionated stereotactic radiotherapy and intracranial and head and neck IMRT. The first system was developed at the University of Florida and is commercially available under the trade name FreeTrack by Varian, Inc. The optical tracking system operates in head and neck IMRT by using an array of two planar CCD cameras surrounded by a ring of infrared light-emitting diodes, to optically track the position of either active or passive infrared markers arranged in an array to form a fixed rigid body. Prior systems may fix the camera in a specific location by mounting it on the wall or may put up cameras in a temporary location by using some tripod stand. The most logical origin for clinical use in radiotherapy is of course the treatment machine isocenter, with the coordinate axes located parallel to the vertical, lateral and longitudinal motions of the treatment area. Other current systems include 3D Guidance spotLight system by Ascension Technology Corporation. This tracking system dynamically bridges the gap between patient movements while on a treatment couch and the direction of a linear accelerator's radiation beams. The Guidance spotLight system takes the motion of a person only. Another system contains magnetic field sensors and optical sources are placed on the person, each located on different limbs. A fixed transmitter emits electromagnetic energy and the infrared light is transmitted from the optical light sources to the fixed optical sensors. The computer calculates each sensor's position and orientation relative to the fixed transmitter. The optical system's position sensing detector measures the transmitted infrared light and the computer calculates the position and orientation of each optical light source. The system will be interfaced to safety servo controllers, monitoring deflections of the patient. The system data can be used to stop and re-target beams, synchronize beam delivery. Furthermore, Ascension Technology Corporation also operates the Optical system for determining the angular position of a radiating point source and method of employing as stated in U.S. Pat. No. 7,756,319; Sensor for determining the angular position of a radiating point source in two dimensions and method of operation as stated in U.S. Pat. No. 7,161,686; Position and orientation determination using stationary fan beam sources and rotating mirrors to sweep fan beams as stated in U.S. Pat. No. 6,473,167; and, System for position and orientation determination of a point in space using scanning laser beams as stated in U.S. Pat. No. 6,417,839. However, these systems only measure the position, but never measure the dose in conjunction with position.

Patient localization is detected by a number of at least 4 markers. The different markers are statically positioned on the patient. The patient position is determined by taking the optical tracking information and comparing it to the desired patient position, which is the patient's position during treatment planning. To determine a reference point, the fiducial array is locked in place during a CT scan, and the image coordinates of the markers are determined as part of a treatment plan. During the treatment plan, the desired target, or isocenter, coordinates are determined in CT space. The center of all the markers, which is determined by distance of each marker, is then calculated to determine the center point. After the center point is determined, it is then compared to the distance of the isocenter, which defines a steroatactic coordinate system. The system will also calculate the residual error between the image localization and the marker and the known geometry after the best fit is obtained. The mean registration error provides quality assurance measure for frameless localization, as it ensures integrity of both the fiducial array and image data set. These set are performed only within treatment planning stage.

However, during patient setup, some systems determine the patient's position and report the displacement form isocenter in real-time. The systems may report translational misalignment from the isocenter as well as the rotational misalignment. When the system detects some form of misalignment, the patient may be repositioned to the desired position. The system monitors the patient's movement only in the real-time and if the patient's movement is greater than a certain distance then the treatment is interrupted. However, this system has a flaw since movement alone would not be enough to determine the dose that was exposed to the patient. The system does not measure the dose related to the position, thus causing patient's healthy tissue to be exposed to radiation. Furthermore, the problem with optical trackers is that some system may block camera's visual site between optical marker leading to a loss of localization signal and can result into exposure to radiation of the healthy tissue cells. In addition, the loss in localization sometimes does not allow the system to re-calibrate back to the region of interest and therefore resulting in an entire reboot of the system. Also, another problem is the difficulty of position tracking in implanted areas as device cannot be implanted with all markers, and still be trackable by cameras. Therefore, there is a need for a system that can overcome the problem of loss of localization while measuring radiation, by having a system that uses an optical tracking system with another patient positioning tracking system to measure position and dose simultaneously. Next, there is a need for a system to gate Linacs for treatment delivery as the position deviation above a preset limit can lead to a stopping of the Linac beam. Further, there is a need for a system to determine the target dose verification as the dose calculation position is accurate. In addition, there is a need for a system to monitor implanted devices when the optical marker is attached to a rigid support, which will contain a dosimeter implanted at a depth, with its position determined using the vector orientation and distance obtained from the optical marker.

### SUMMARY OF INVENTION

According to one general aspect, there is provided a DosiLoc apparatus for accurately measuring radiation beams during treatment which comprises a dosimeter which is used to measure the radiation; an optical marker which is used to determine a patient's position; and said dosimeter and said optical marker are connected to one another used to provide simultaneously a radiation dose reading and a measurement of patient's movement during treatment. Further, the DosiLoc apparatus for accurately measuring radiation beams during treatment, wherein said dosimeter is an IGFET, a MOSFET, a diode, a PIN-diode, a floating gate MOSFET, a dual-MOSFET, or a single MOSFET, a film, a TLD, OSL. In addition, the DosiLoc apparatus for accurately measuring radiation beams during treatment, wherein said dosimeter and said optical marker can be set on a flexible or rigid substrate. The DosiLoc apparatus for accurately measuring radiation beams during treatment, further comprising a support object that holds the optical marker which can be set to a flat or vertical position in relation to a surface of the patient or radiation beam. Additionally, the DosiLoc apparatus for accurately measuring radiation beams during treatment, wherein said optical marker and a cover are disposable for single use. Further, the DosiLoc apparatus for accurately measuring radiation beams during treatment, wherein said optical marker and a cover are reusable by a sterilization process. Next, the DosiLoc apparatus for accurately measuring radiation beams during treatment, wherein said optical markers can be used on a substrate with said dosimeter. In addition, the DosiLoc apparatus for accurately measuring radiation beams during treatment, wherein a plurality of dosimeters and a plurality of optical markers are located on a single substrate in alternative order to create a matrix cell. Moreover, the DosiLoc apparatus for accurately measuring radiation beams during treatment, further comprising: said optical marker can be any spherical, cylindrical, flat, tetrahedral, cubic, or hollow shape. Additionally, the DosiLoc apparatus for accurately measuring radiation beams during treatment, wherein said optical marker can be of any reflective type comprising copper, gold, aluminum, sliver, or any optical material with reflective properties. Next, the DosiLoc apparatus for accurately measuring radiation beams during treatment, wherein said optical marker varies in thickness to allow radio-opacity for optical localization from cameras and visibility from x-ray imaging devices simultaneously. Plus, the DosiLoc apparatus for accurately measuring radiation beams during treatment, wherein said dosimeter attaches to a support means, which further comprises a connector connected to a dose reader; and said dose reader can transmit wirelessly said radiation dose reading to a computer or through wired connection, while having said optical markers track motion using a plurality of cameras to transmit said measurement of the patient's movements to display both information on one or more display apparatuses. Further, the DosiLoc apparatus for accurately measuring radiation beams during treatment, wherein said support means can be attached by a permanent or a detachable connector to said dose reader. Also, the DosiLoc apparatus for accurately measuring radiation beams during treatment, further comprising said dosimeter monitors dose continuously while patient position is monitored at a fixed time interval, and conversely said optical marker monitors patient position continuously while dose is monitored at a fixed time interval. Plus, the DosiLoc apparatus for accurately measuring radiation beams during treatment, further comprising said dosimeter monitors dose continuously while patient position is monitored at a fixed time interval, or conversely said optical marker monitors patient position continuously while dose is monitored at a fixed time interval. Further, the DosiLoc apparatus for accurately measuring radiation beams during treatment, wherein said radiation dose reading and said measurement of the patient's movements can be displayed on different display apparatus and in a combination of graphical or table format settings of dose and position parameters. In addition, the DosiLoc apparatus for accurately measuring radiation beams during treatment, further comprising said dose reader and said optical marker are wireless and dose measured by MOSFETs or floating gate MOSFETs, while the position is still monitored continuously with said optical marker. Also, the DosiLoc apparatus of claim 8 for accurately measuring radiation beams during treatment, further comprising said dosimeter can be in an array configurations with said optical markers attached between dosimeters, allowing simultaneous localization and dose measurement in a given dosimetry session. Furthermore, the DosiLoc apparatus for accurately measuring radiation beams during treatment, wherein said array configuration comprises a linear shape, a 2-D shape, or a 3-D shape at different depths. Moreover, the DosiLoc apparatus for accurately measuring radiation beams during treatment, further comprising an array of dosimeters is inserted in tubes or catheters, temporarily or permanently, and whereby said optical markers are attached to surface tube at preset locations in relation to said array dosimeters, allowing reflection and optical localization of the dosimeters. Also, the DosiLoc apparatus for accurately measuring radiation beams during treatment, wherein said dosimeter is covered with an optical marker of hemispherical shape to provide simultaneously build-up material configuration and dose measurement at different depths representative of a tumor location. In addition, the DosiLoc apparatus for accurately measuring radiation beams during treatment, wherein said optical marker is composed of plastic composite (density close to water) or a dense metallic material that reduces said DosiLoc size in high photon, electron or proton energy settings. Further, the DosiLoc apparatus for accurately measuring radiation beams during treatment, wherein said optical marker is used in combination with a magnetic sensor to allow absolute optical localization and accurate referencing of a magnetic based sensor. In addition, the DosiLoc apparatus for accurately measuring radiation beams during treatment, wherein said optical marker is printed permanently on the magnetic sensor or attached temporarily as a cap on its surface with possible removal. Also, the DosiLoc apparatus for accurately measuring radiation beams during treatment, wherein said optical marker can be printed on the dosimeter itself or on its build-up cap. Plus, the DosiLoc apparatus for accurately measuring radiation beams during treatment, wherein said dosimeter can be a TLD (thermoluminsecent) with said optical marker coating on one face while another side is not coated to allow for radiation dose reading. Furthermore, the DosiLoc apparatus for accurately measuring radiation beams during treatment, wherein said dosimeter can be an OSL (optically stimulated luminescence) in a black container, coated with an optical marker. Additionally, the DosiLoc apparatus for accurately measuring radiation beams during treatment, wherein said optical marker can be a diode emitter with light constantly analyzed by cameras; and whereby said diode emitter being powered by a battery supply or by light through photocells integrated into said diode emitter to alleviate surface contamination issues in relation to passive markers. Further, the DosiLoc apparatus for accurately measuring radiation beams during treatment, wherein said optical marker is composed of fluorescent material for low light conditions. In addition, the DosiLoc apparatus for accurately measuring radiation beams during treatment, wherein said optical marker position is used as a reference for other said optical markers, providing relative motion at a given location. Further, the DosiLoc apparatus for accurately measuring radiation beams during treatment, further comprising: a phatom that is a plurality of block materials in substitute of a patient attached to said DosiLoc device used to monitor, in real-time treatment delivery, by said optical marker phantom movement, alleviating thereby magnetic interference issues relating to surrounding metallic objects and control systems. Plus, the DosiLoc apparatus for accurately measuring radiation beams during treatment, further comprising said dosimeter is composed of a film that is attached to said optical marker that provides average position, patient shift and dose during radiotherapy procedures.

### DESCRIPTION OF THE DRAWINGS

FIG. 1 is a diagram illustrating a system overview of the tracking device in junction with a dosimetry system in a therapy setting.

FIG. 2A is a diagram illustrating the DosiLoc device connected by wires to the Reader.

FIG. 2B is a diagram illustrating the DosiLoc device connected wirelessly to the Reader.

FIG. 3 is a diagram illustrating a combination of an X-ray imaging device with the DosiLoc device having the optical marker radio-opaque to radiation for simultaneous X-ray and optical localization.

FIG. 4A is a diagram illustrating an integration of the optical marker with a passive dosimeter (TLD, OSL).

FIG. 4B is a diagram illustrating the DosiLoc device as an integration of an optical marker with an active dosimeter device (Diode, IGFET: MOSFET, Floating gate MOSFET).

FIG. 4C is a diagram illustrating a dosimeter covered by reflective and dense material (build-up).

FIG. 5 is a diagram illustrating a belt that contains an array of dosimeters and optical markers.

FIG. 6 is a diagram illustrating an array of dosimeters inserted in a tube catheter having optical marker patterns printed on its surface.

FIG. 7 is a diagram illustrating a combination of optical marker and electromagnetic sensor for position tracking of a dosimeter.

FIG. 8 is a diagram illustrating the DosiLoc device using light emitting diodes (LED) as position markers.

FIG. 9 is a diagram illustrating the DosiLoc device setting on a phantom to monitor simultaneously target dose and position in 3D motion.

FIG. 10 is a method of operating optical marker with dosimeters in a therapy setting.

FIG. 11 is a method of using DosiLoc device in combination with radio-opaque markers to determine absolute reference of the dosimeter.

### DETAILED DESCRIPTION

The following detailed description is provided to assist the reader in gaining a comprehensive understanding of the methods, apparatuses and/or systems described herein. Accordingly, various changes, modifications, and equivalents of the systems, apparatuses, and/or methods described herein will likely suggest themselves to those of ordinary skill in the art. Also, descriptions of well-known functions and constructions are omitted to increase clarity and conciseness.

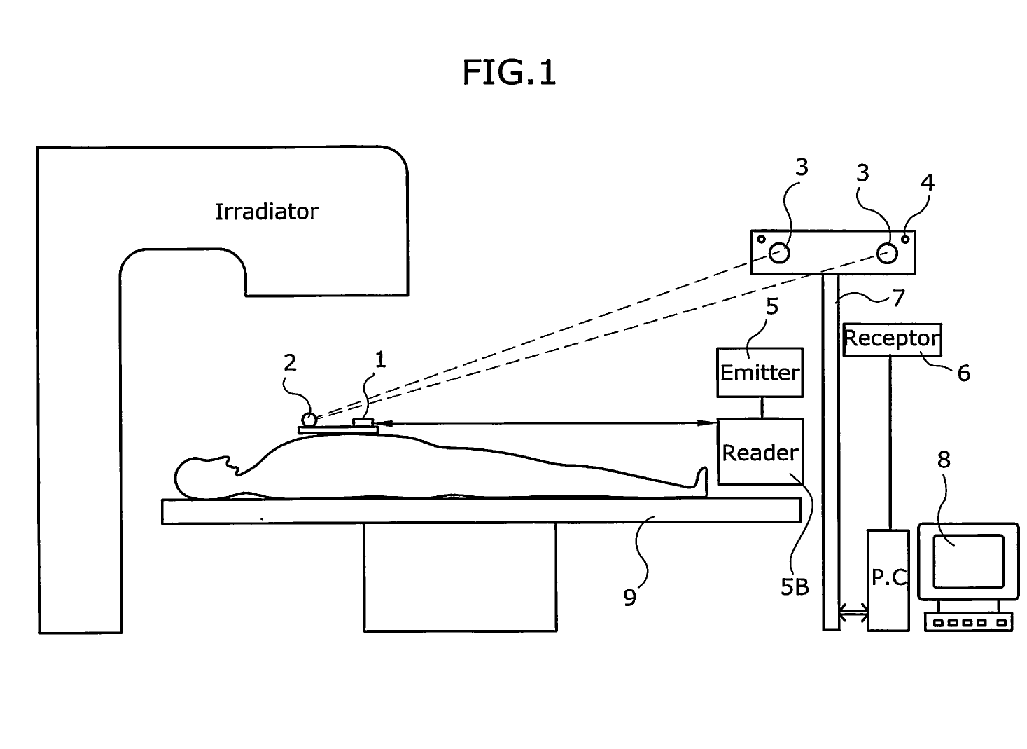

FIG. 1 illustrates how the DosiLoc is placed on the patient while having treatment performed. The DosiLoc contains a dosimeter 1 and an optical marker 2. The optical marker 2 is viewed by the camera 3. The camera 3 can be mounted on the wall, ceiling or may be placed on tripod stands 7. The camera support 7 can be static on fixtures determined by user in the treatment room (patient bed, ceiling, or etc.), while allowing line of sight with the optical markers 2. Alternatively, the camera support can be moved manually or automatically when attached to a console driven by electric motors, which in turn is controlled remotely by a computer or a hand held device. Looking specifically, the dosimeter 1 can be connected to a reader. The connections between dosimeter 1 and Reader 5B can be wired or wireless. The dosimeter 1 is positioned closely to the optical marker; it can be connected through wire leads to a reader located at patient vicinity or attached to patient treatment table, away from the radiation beam to avoid possible damage to its circuits. The reader analyzes the data from the dosimeter 1 and sends the information to the emitter 5. Alternatively, the reader can have an LCD display and buttons to allow dose readings and control through faceplate buttons. The reader mode of operation can be continuous dose measurement or single reading mode at time intervals set by the user. The emitter 5 takes the information and transmits to the receptor 6. The receptor 6 receives the information via wirelessly (via IEEE 802.11a, IEEE 802.11b, IEEE 802.11g, IEEE 802.11n, IEEE 802.16, BlueTooth, ZigBee, HomeRF, HiperLan/1, HiperLan/2, OpenAir, and any future protocols) or wired then communicates to the PC or any hand-held device to view on a display apparatus 8. The reader mode of operation can be continuous dose measurement or single reading mode at time intervals set by the user. Dose data can be monitored, processed, and displayed.

Next, the optical marker 2 operates by the light emitter 4 shooting light waves towards the patient. The wave length of light can be a variety of light waves. The imparted light from light emitter 4 reflects off the optical marker 2. The reflection of light by the optical marker 2 is then read by the optical marker reader 3. The optical marker reader 3 computes the location of the reflected optical marker 2 into a 2-D or 3-D grid. The optical marker reader 3 is able to compute the locations of up to three (3) or more optical marker 2 within a single a 2-D grid. After capturing all data from the optical marker 2, the optical marker reader 3 sends the information in parallel to the computer for processing. Specifically, the motion parameters such as periodicity (frequency) and amplitude are assessed by computer algorithms applied to acquired position data. Position information can be displayed graphically as position in mm, cm, meters or any metric units, in function of time for X, Y, and Z coordinates. Radial or vector distance can be also displayed. The refresh rate of data can be as fast as possible (˜ms range), or set by user at higher time intervals (˜seconds or minutes). Data can be displayed in 3-D graphs, with data marker coordinates provided in X, Y, and Z coordinates and updated in real time during operation. At conditions where the light interferences are present, light emitting diodes (LED) can be used as a light emitters at a fixed wavelength, with the reflected signal from the markers detected to allow its discrimination from undesirable interfering signals. The DosiLoc device integrates optical markers 2 with a dosimeter 1; the X, Y, Z coordinates of the dosimeter are related to in determining the absolute reference (isocentre) by the processing of the marker's data.

It is desirable to have a plurality of DosiLoc devices used simultaneously during a same session. Each DosiLoc device can be read and monitored by a separate camera and dosimeter reader or in combination there from as described above; however, the information obtained in relation to spatial localization and dosimetry by various DosiLoc devices can be processed in real-time to determine and display position and dose at different locations, or relative motion of a moving DosiLoc device in comparison to another reference DosiLoc device. This setting is desirable to monitor patient motion in relation to a reference location at the patient vicinity such as a treatment table, stand, or body part.

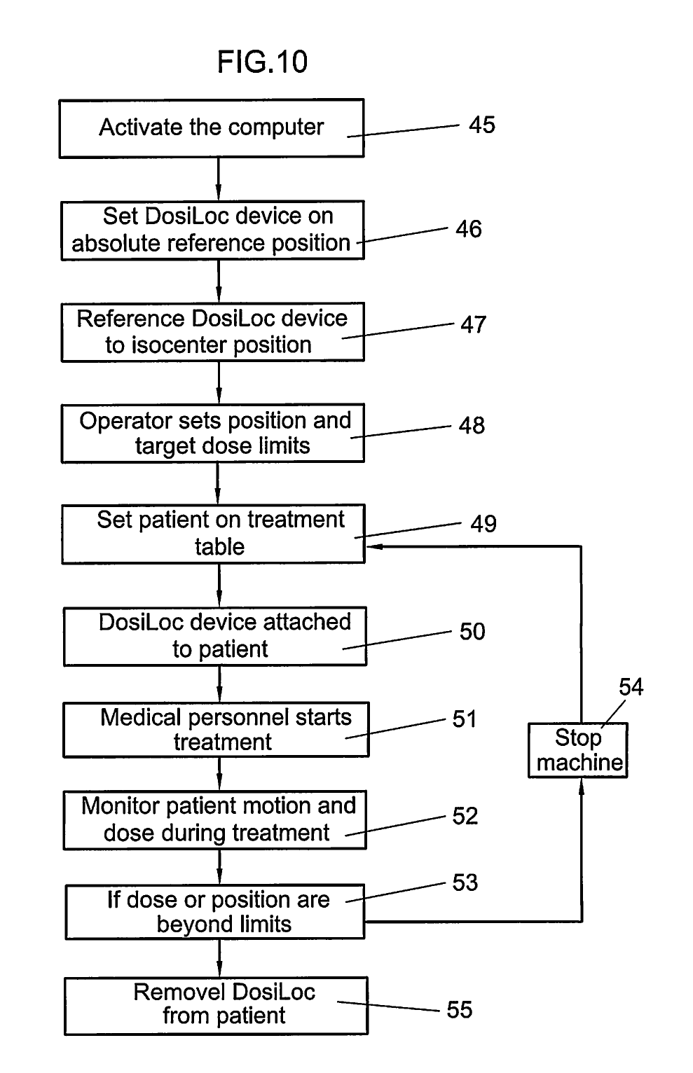

FIG. 10 demonstrates the method of operating the DosiLoc device. First, a medical personnel opens a computer session preferably outside the treatment room and establishes connection to dose and position reading system 45. Next, the medical personnel sets the DosiLoc device on a bloc support at the isocentre of the machine determined independently by lasers 46. Absolute reference could be another fixed location such as table surface, in FIG. 1 item 9. Thereafter, the medical person performs position readouts and sets absolute position reference to the isocentre 47. Next, the medical person sets position and target dose limits as defined in the treatment planning system for a given patient 48. After that, the patient is set on the treatment table 49. Subsequently, the DosiLoc device is attached to the patient's skin at a location where motion monitoring is desirable 50; markers are in line of sight with cameras on ceiling or stand 50. The medical personnel start the treatment to the patient 51. The medical personnel monitor patient's motion and dose during treatment 52. If, the dose or position are beyond limits 53; the system and treatment will stop 54. Thereafter, the medical person will have to set the position for target dose 49. Afterwards, the medical personnel will have to start the treatment again 51 and will monitor the treatment of the patient 52. If the dose or position has not exceeded the limit, when the treatment is complete, dose and position are compared to preset limits and all deviations are analyzed 55.

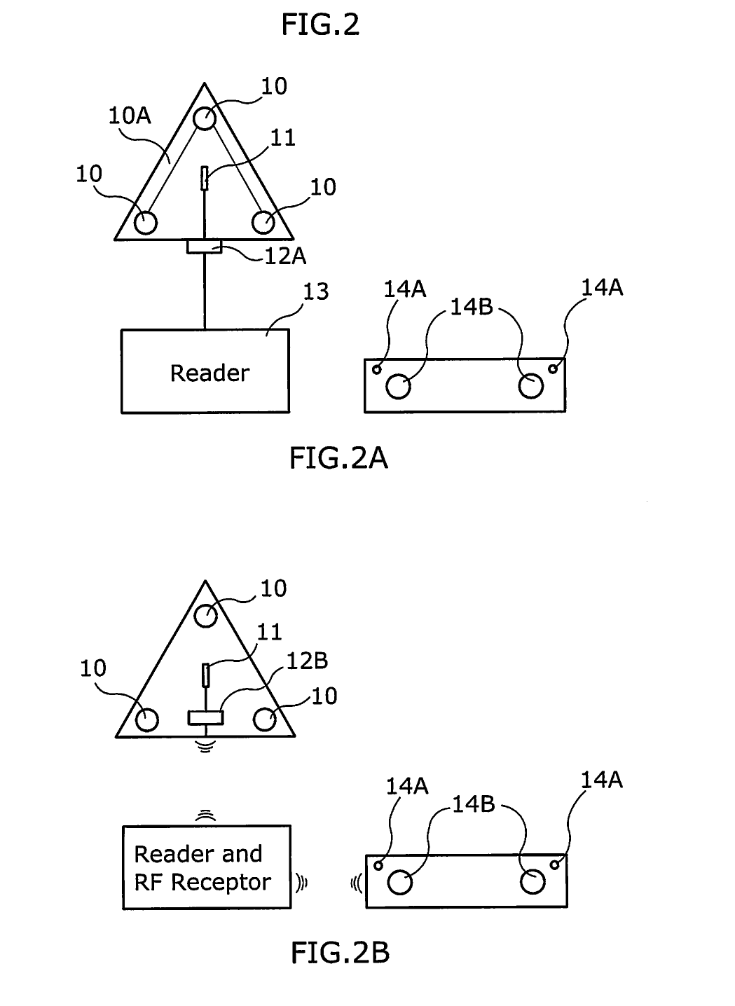

FIG. 2A illustrates the DosiLoc. The DosiLoc, for only illustration purposes has only three (3) optical markers 10, a single dosimeter 11, connector 12A, a wired reader 13 and optical marker camera 14. The optical markers 10 are fixed to each board 10A. The board 10A can be made of material that is rigid or flexible (fiber, polymer, plastic, etc.). For illustration purposes, the optical markers 10 are positioned in a triangle shape. The three (3) optical markers are positioned in a triangular configuration on a support with the dosimeter positioned equidistantly to each marker for easy localization using the information provided by the three markers. The isocentre location is determined using the median rule in a triangle configuration, or other mathematical method of isocentre calculation for complex configurations. Thereafter, you should have a value of the center of X-coordinate, Y-coordinate, and Z-coordinate, which are the dosimeter coordinates. This allows optical reader to determine the center of the optical markers. Furthermore, the single dosimeter 11 will do an individual reading. It is desirable to attach the dosimeter leads to a wire connector 12A, which connects the dosimeter support to an electronic readout system, which in turn is connected to a computer wirelessly or via USB or RS232 cable connection. The markers, coated with reflective materials, can be of any shape (cylindrical, flat, cubical, etc.), the hemispherical shape being preferable as it allows for omnidirectional response to light emitted from different locations. The dosimeter operation is incorporated in here as by reference Patent AP949 GB91111005 Jul. 2, 1991 Direct reading dosimeter Issued—May 21, 1997 0471957; AP950 US08/072,710 Jun. 7, 1993 Flexible Radiation Probe, Issued—Aug. 22, 1995 5,444,254; AP687 U.S. Pat. No. 09/796,795 Mar. 2, 2001 Radiation sensor and dosimeter incorporating same, Issued—Sep. 2, 2003 6,614,025; AP818 U.S. Pat. No. 08/978,595 Oct. 18, 2001 Computer assisted radiotherapy dosimeter system and software therefore Issued Nov. 18, 2003, 6,650,930; AP1071 US11/198,159 Aug. 5, 2005 Dosimeter having an array of sensors for measuring Ionization radiation, and dosimetry system and method using such a dosimeter.

FIG. 2B illustrates only three (3) optical markers 10, a single dosimeter 11, wireless emitter 12B, a wireless reader 13 and optical marker camera 14; however, the system can be configured to include any number of optical markers with any number of dosimeters for multiple readings. The DosiLoc can communicate wirelessly to other component parts. The dosimeter of FIG. 2B is connected to a miniature RF emitter which converts raw sensor readings (mV) to an RF signal, for wireless detection by a reader which uses an RF receptor; the dosimeter readout is processed in conjunction with position data to allow simultaneous dose and position data monitoring and display by a computer. Looking specifically, the DosiLoc can respond to the light emitters 14A with reflected light detected by an optical marker camera 14B. In a variation of the set-up, and to avoid cumbersome cables of the camera in confined areas, the camera module transmits wirelessly its data to the same dose reader which transfers all data to a computer for extensive monitoring and processing. Further, the dosimeter and optical marker information are measured simultaneously with a radiation dose. In future modification, there can be any number of dosimeters and optical markers that are used to communicate among each other.

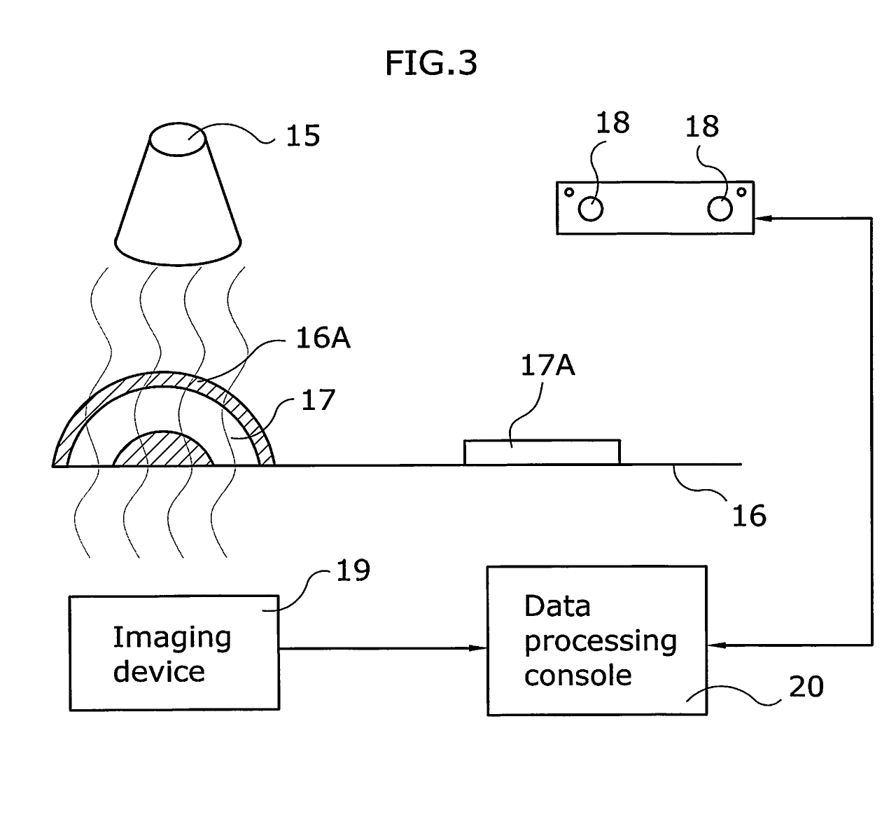

FIG. 3 illustrates a DosiLoc apparatus that contains an x-ray radio-opaque marker inside the optical marker. This is used to determine absolute reference of both an optical marker 16A and x-ray radio-opaque marker 17. Used for patient imaging, in some instances, where x-ray imaging methodology is present on site, it is possible to gain more insight with regard to the DosiLoc device localization in relation to the tumor itself. An x-ray source 15 can be any type of radiation source low level or high level or gamma. FIG. 3 illustrates the combination of optical marker position determination methodology with the x-ray imaging methodology. The optical marker contains different types of materials. The first layer is the reflective material which is optical marker 16A, and the second material is the radio-opaque marker 17 that is used for visibility under x-rays. The radio-opaque marker 17 can consist of many different types of materials, which can be lead, gold, tungsten, brass, and any other type of metal that is radio-opaque to x-ray photon radiation. In addition, for improved reflection, the radio-opaque markers 17 can be coated with highly reflective materials such as silver paste, metal oxides, gold, etc.

In operation with a patient, the x-ray source emits photons, which are absorbed by the radio-opaque markers 17 of the DosiLoc device, projecting an image of the markers on a flat panel display or imaging device 19. This x-ray image can be viewed and processed in a data processing console 20 to determine the dosimeter coordinates X, Y, Z in relation to an absolute reference (isocentre) located on the film image, or to the tumor/organ of interest. Simultaneous to the x-ray imaging, the optical markers 16A, which are monitored by the cameras, provide independently the location of the DosiLoc device and its coordinates using optical methods.

At a given time it is desirable to process both of the DosiLoc images to relate and correlate the dosimeter position obtained using cameras 18 (optical method) to the position of reference (Tumor, organ at risk, isocenter, etc.) given by the image resulting from x-rays. The new synchronization of the DosiLoc device position to a known position of reference tumor allows a user to gain information on tumor motion using position data determined at the patient surface by monitoring the optical markers 16A by cameras 18. One of the benefits of this methodology is to reduce x-ray scatter irradiation dose to the patient during lengthy procedures, where tumor motion monitoring is of an essence such as for lung tumor. Further, the imaging device 19 may be a flat panel, film, cone beam CT scans, or digital image.

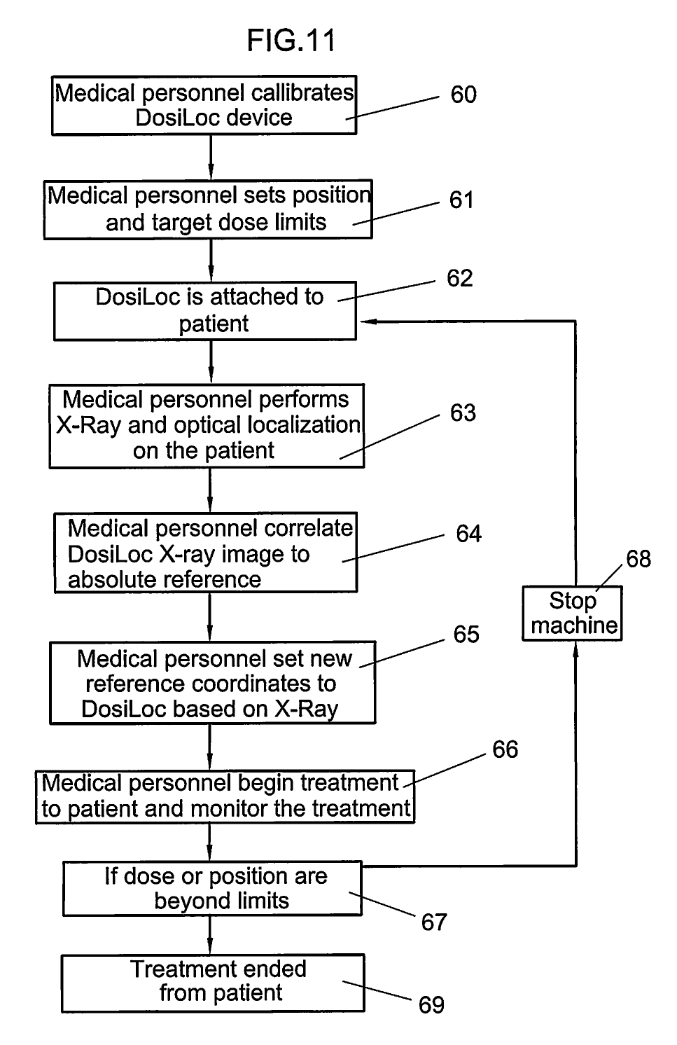

FIG. 11 demonstrates the method using a fiducial marker with dosimeters to determine absolute reference. First, user opens a computer session and performs position readouts and sets absolute position reference to the isocentre 60. Next, medical personnel set the position and target dose limits as defined in the treatment planning system for a given patient 61. The DosiLoc device is attached to the patient's skin at a location where motion monitoring is desirable; markers are in line of sight with cameras on ceiling or stand 62. Subsequently, medical personnel exposes patient to x-rays with simultaneous optical marker position detecting using cameras 63. Then, medical personnel loads the x-ray image (from flat panel or CT scan) of the DosiLoc device associated with patient anatomy and determines device coordinates to an absolute reference in relation to the isocentre or other anatomical location (organ/tumor) of interest 64. The medical personnel set a new reference coordinates to the DosiLoc based on x-ray image 65. The medical personnel begin the treatment to the patient and continuously monitor the patient's motion amplitude and dose during treatment delivery, with constant comparison to preset limits 66. If, the dose or position are beyond limits 67; the system and treatment will stop 68. Thereafter, the medical person will have to set the position for target dose 62. Afterwards, medical personnel perform an x-ray and optical localization on the patient 63. The medical personnel will, again, have to correlate the data to the patient 64. Then, the medical personnel sets new reference coordinates to DosiLoc based on x-ray image 65. The medical personnel then resumes the treatment of the patient while simultaneously monitoring the patient 66. If the dose or position has not exceeded the limit, the treatment is complete and DosiLoc device is removed 69.

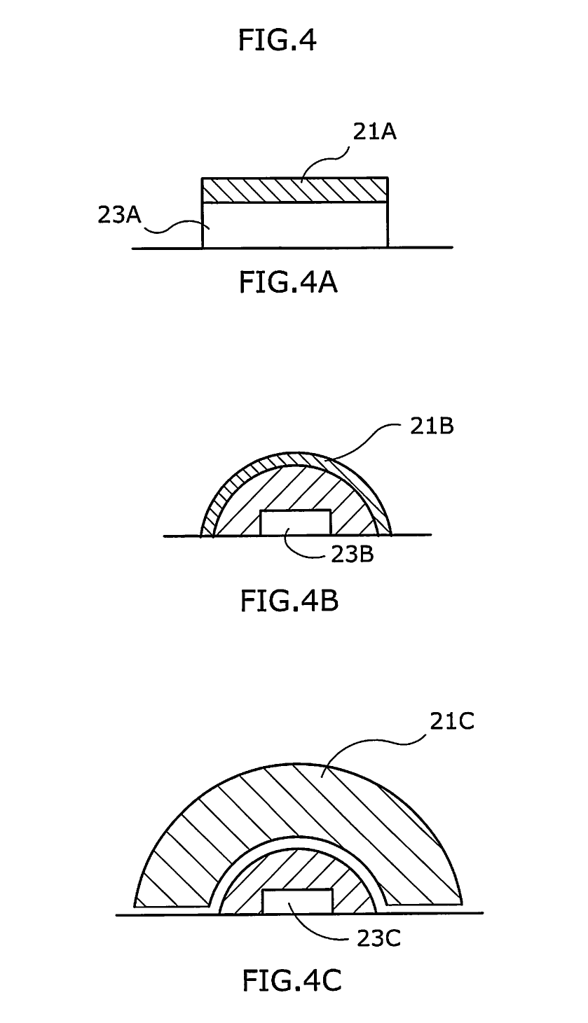

In confined space areas where small irradiation field zones, such as in stereotactic surgery or in curved locations, are present, the DosiLoc device support in a triangular shape with multiple markers has some limitations. It is desirable to reduce the size of the device and integrate the dosimeter with the optical position marker as described in FIG. 4 for passive and active dosimeters. FIG. 4A is a diagram illustrating an integration of the optical marker with a passive dosimeter. Specifically, the dosimeter can be an OSL (Optically Stimulated Luminescence) or TLDs (Thermoluminescent). The difference between the OSL and TLD is that the OSL dosimeter 23A is an optically stimulated luminescence dosimeter, meaning that you use a laser to read the change in the material after it has been irradiated; whereas in the case of a TLD, the dosimeter is heated resulting in light emitted from the irradiated material. We can integrate the optical marker 21A with the OSL dosimeter 23A. It is desirable to attach a reflective coatings (flexible adhesive such as Polyester coated with reflective material such as silver, gold, metal oxides) on their surface, and then place them on the patient zone where position monitoring is important. In this configuration, the dose will not be monitored in real-time during the procedure, but determined at a later time; however, this configuration allows for a determination of the dosimeter coordinates using cameras, and for precise dose verification using treatment planning software at a known location of the patient. One of the advantages of this configuration is the small size of the DosiLoc device and the DosiLoc device does not contain wires. The dose reading could be obtained using known processing methodologies (heat for TLDs and light for OSL dosimeters). The optical reflective coating could be permanently attached to the dosimeter or temporary depending on the readout requirements of the dosimeters.

It is desirable in skin surface dose measurement to have the DosiLoc devices composed of optical markers attached on a thin film surface, the thin film being used for dose measurement. In this setting, the optical markers will provide in real-time the location of the center of the film during patient treatment, hence, allowing patient position shift determination in addition to dose at a known location at the end of the treatment.

FIG. 4B illustrates the DosiLoc device that is an integration of an optical marker 21B and an active dosimeter device 23B (direct readout), which can be a diode, IGFET (MOSFETs, Floating gate MOSFETs, and etc.). The optical marker 21B can be composed of reflecting coating material, temporary covering the dosimeter (tape), or permanently attached to the packaging of the dosimeter using silver paste or other coating deposition techniques as known in the art (vacuum deposition, evaporation, immersion, etc.). Further, the advantage of the DosiLoc device is the camera will determine position of the reflective material while the dose reading is obtained from the dosimeter device 23B simultaneously and provide the medical personnel with real-time verification of dose, position and comparison to treatment preset limits.

FIG. 4C illustrates the DosiLoc device that is integrated with an optical marker 21C and an active dosimeter device 23C (direct readout), which can be a diode, IGFET (MOSFETs, Floating gate MOSFETs, and etc.) with a build-up material between or combined with the optical marker 21C. In special radiation treatment configurations, the dose at depth, or at Dmax (depth of maximum dose delivery at a given beam energy) is required to allow accurate comparison to treatment plan calculated dose at a given location in a tumor. The configuration of FIG. 4B needs to be modified by adding significant material thickness on the dosimeter 23 (build-up material simulating patient flesh depth close to the tumor), preferably of hemispherical shape, and ideally of high density such as Brass, tungsten, lead or any other material that will show up in an image to provide equivalent depth close to Dmax. The build-up material is coated with reflective coating for easy camera localization as described in FIG. 4C. The device mode of operation is similar to the description in FIG. 4B; however, the dose is determined at Dmax as opposed to the surface in the case of FIG. 4B. Therefore, the DosiLoc in FIG. 4C allows for a total build-up dose measurement with real-time position measurement.

It is desirable in situations where radiation beam is large enough that a multiplicity of dosimeters are used to monitor the beam characteristics, in addition to a multitude of markers to determine their locations, when a target is moving (moving phantoms, moving patient with a large treated area, etc.). This is the case for modem radiotherapy beams using wider fields such as IMRT, and which involve a variety of shapes and angles.

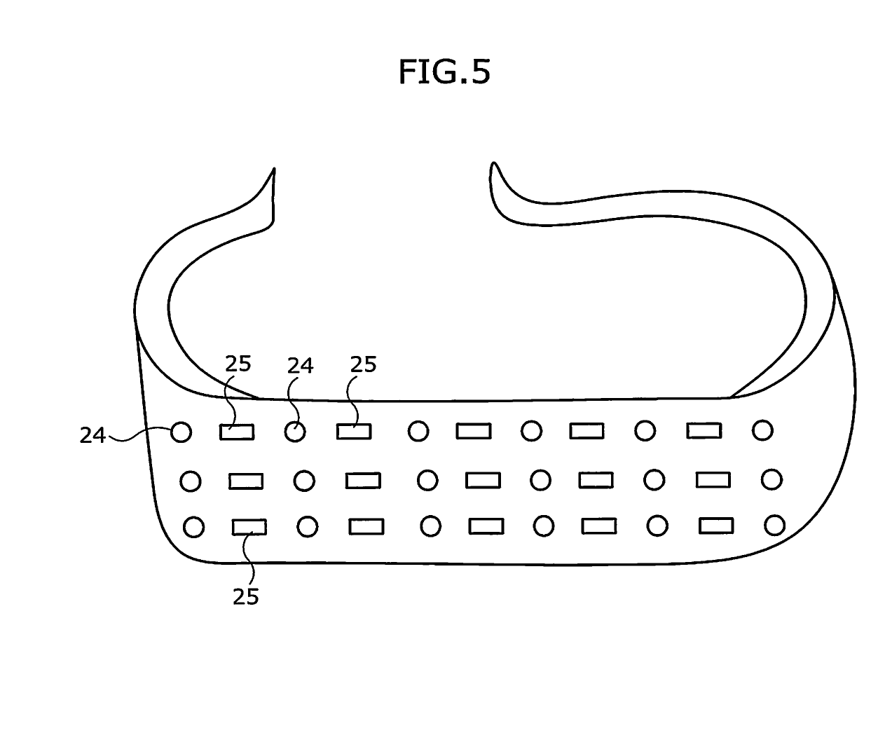

FIG. 5 illustrates a belt that contains an array of dosimeters 25 and optical markers 24. A flexible (or rigid) support, and which encompasses an array of dosimeters 25 spread between optical markers 24 on a belt support, is used. In FIG. 5, each dosimeter 25 uses two (2) adjacent optical markers 24 for localization. The camera recognition of the belt marker patterns and the known position relation of the dosimeters to these markers will allow dynamic tracking and monitoring of patient motion in a wider area, while having simultaneously dose measured at various locations on the surface.

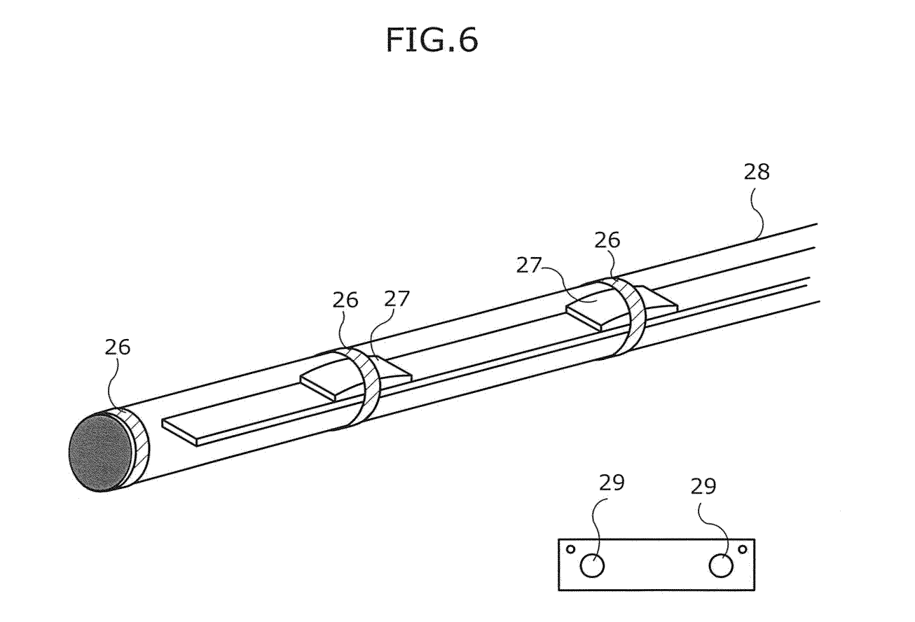

FIG. 6 illustrates an array of dosimeters 27 inserted into a thin catheter 28 having optical marker 26 patterns printed on its surface. In conditions where the sterilization of the dosimeter/marker combination is required to avoid contamination between patients, it is desirable to have the optical marker means, which are in touch with patient skin, sterile and disposable (single use), while keeping the dosimeters reusable. To this end, the configuration shown in FIG. 6 is desirable, as it allows a dosimeter in an array configuration (multiple sensors as described in United States Publication 2006-0027756) to be inserted in a catheter, which in turn has optical markers at its surface at defined locations, allowing dosimeter localization.

Composed of reflective coatings, the optical markers 26 can be printed or taped in different shapes on the catheter, the ring shape being preferable. As illustrated in FIG. 6, optical markers 26 are spaced apart evenly by a predetermined distance, but can be separated irregularly depending on the dosimeters' inter-separation in the array. Ideally, each dosimeter should be affected to a marker; however, this is not necessary as multiple markers could be allocated to one dosimeter. Last, the catheter 28 has closed ended section to prevent ingress of liquids and contaminants to the dosimeter, and to allow fixed dosimeter array reference to the catheter optical markers when the array tip is touching the closed ended section.

Array dosimeters 27 can be composed of TLDs, OSLs, IGFETs , Diodes, in configurations as described in United States Publication 2006-0027756 filed by applicant. The catheter 28 could be flexible or rigid depending on the surface of use of interest. The array dosimeter 27 can be temporary inserted in the catheter, and removed after each use; this is desirable in the case of patient contact to avoid cross contamination between patients. The dosimeter array can also be glued permanently to the catheter 28; this is the configuration desirable for multiple uses of the DoisLoc device in situations where contamination is not an issue, or mild surface disinfection is sufficient.

The catheter 28 as shown in FIG. 6 is close ended on one side, with the tip of the dosimeter reaching the tip of the catheter; it is possible to use a clamping device to temporarily or permanently keep the dosimeter array connected to the catheter, and avoid wobbling during procedures and prevent false positive movements by the image processing device.

The method of operating the catheter starts as follows: Insert the dosimeter array 27 inside the catheter and ensure that the array tip has reached the end of the catheter, then, secure the array/catheter combination; next, attach the Array/catheter combination to the patient surface; later, using cameras 29 localize the reflective marker coating 26 on the catheter to determine the array dosimeters locations and their coordinates; next, medical personnel monitor simultaneously the position and the dose during a treatment session and decide to stop the treatment if dose or position are beyond preset limits. At the end of the treatment, removing the dosimeter from the catheter and replacing it with a new sterile catheter and repeat procedure with a new patient.

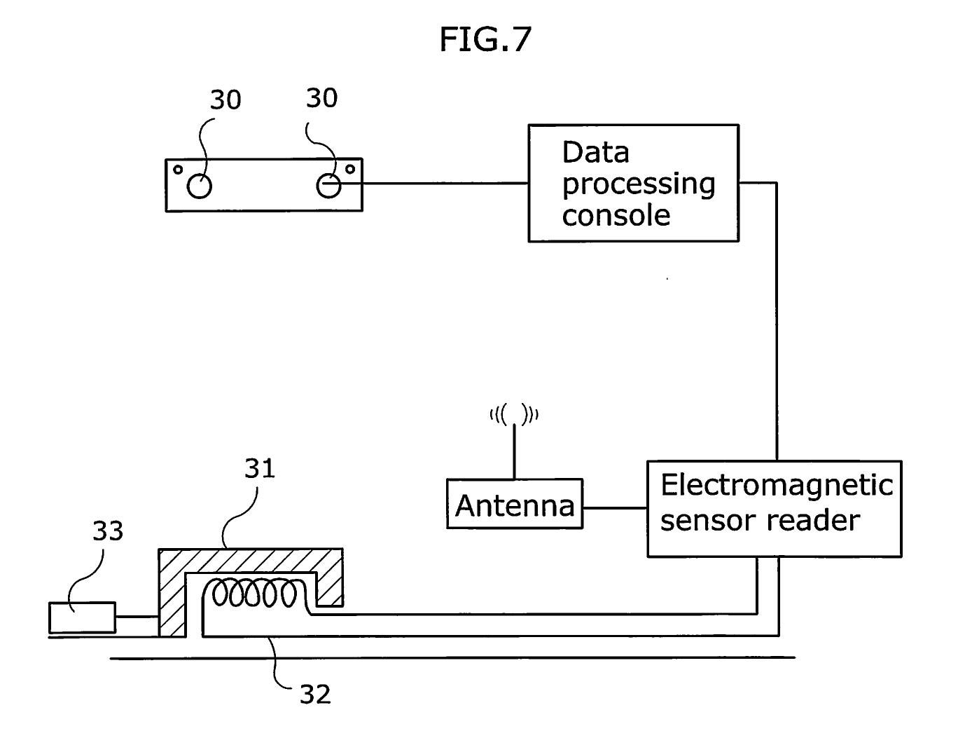

FIG. 7 illustrates a combination of optical marker 31 and electromagnetic sensor 32 for position tracking of a dosimeter 33. In conditions where electromagnetic sensors are used for localization, electromagnetic interference and metals at vicinity of the sensor can affect the device position accuracy. It is then desirable to use additional localization means, not susceptible to electromagnetic interferences, to localize a radiation dosimeter. As described in FIG. 7, a reflective coating marker is attached at the surface of the electromagnetic sensor 32, with position monitored using cameras. The coating material should be of reflective material to allow for an optical marker 31, but thin enough to avoid blocking electromagnetic signal sent by antenna to the electromagnetic sensor. The optical marker 31 can be a cap or material coated over the antenna of the electromagnetic sensor 32. In this configuration, the optical signal, monitored by cameras 30, can be synchronized with the magnetic signal to accurately determine the position of the sensor during a course of a treatment. Simultaneously, a dosimeter 33 can be attached to the vicinity of the electromagnetic sensor 32, to allow simultaneous dose and position measurement.

It should be noted that the cameras redundancy could be avoided using electromagnetic sensors as described in FIG. 7, knowing that position is continuously monitored by the electromagnetic field even if the optical marker is temporary not in sight with the detection camera. The optical marker 31 may be combined with different types of sensors. The electromagnetic field sensors are not accurate since electromagnetic interference or metals at vicinity of the electromagnetic sensor can affect the device's absolute position. The electromagnetic sensors can have absolute positioning error in a percentage of up to 10% deviation. By adding optical marker positioning to the data processing console, we are able to determine the absolute reference by a process of redundancy check. This way the camera is able to view the optical marker 31 and the data processing console is able to read the electromagnetic sensor. Further, the optical marker 31, monitored by cameras 30, can be synchronized with the magnetic signal to accurately determine the position of the sensor during a course of a treatment. Simultaneously, a dosimeter 33 can be attached to the vicinity of the electromagnetic sensor 32, to allow simultaneous dose and position measurement. It should be noted that the cameras redundancy could be avoided using electromagnetic sensors as described in FIG. 7, knowing that position is continuously monitored by the electromagnetic field even if the optical marker is temporary not in sight with the detection camera. The benefit of combining the magnetic field sensor 32 and the optical marker 31 is to correct the lost localization signal by the optical marker 31 and to allow the electromagnetic system to re-calibrate its sensitivity settings when interferences are present.

Other advantages of optical signal monitoring and tracking during radiotherapy procedures using the DosiLoc device is its compatibility with MRI (Magnetic Resonance Imaging) procedures, where strong magnetic fields do not affect the optical position determination, hence providing accurate position measurement and synchronization of DosiLoc device position on the patient with MRI imaged features of the patient body (tumors, etc.); this alleviates limitations of position determination using magnetic sensors in presence of strong and disturbing MRI magnetic fields.

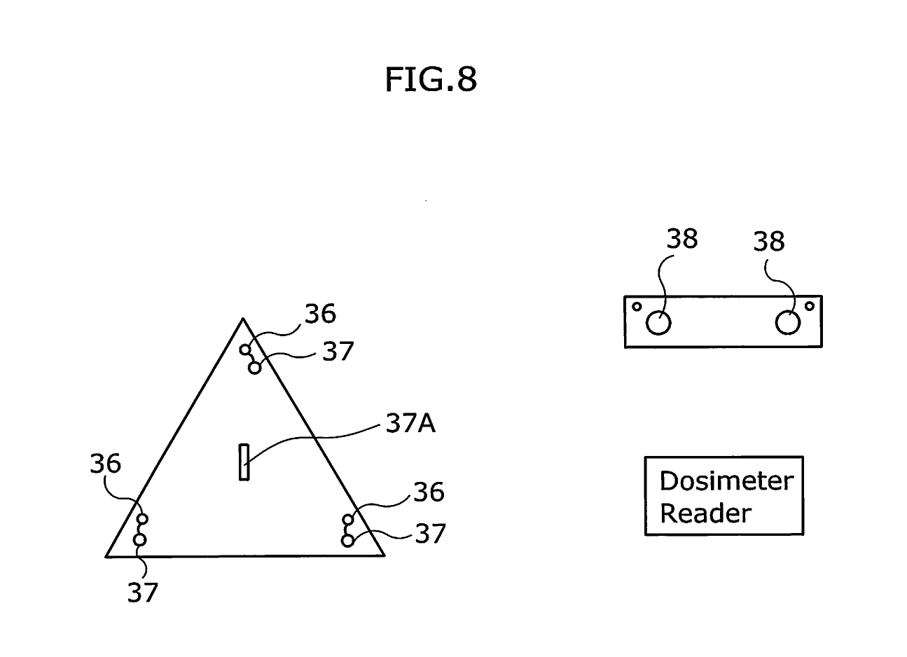

FIG. 8 illustrates the DosiLoc device using light emitting diodes 36 (LED) as position markers. In some conditions where lighting conditions are weak or a dark environment is desirable, or light interference is present, the optical markers can be replaced with light emitting diodes (LEDs), which could be operated by miniature batteries 37 as described in FIG. 8. Such combination will allow continuous tracking of the LEDs signal and the determination of the dosimeter 37A position during irradiation.

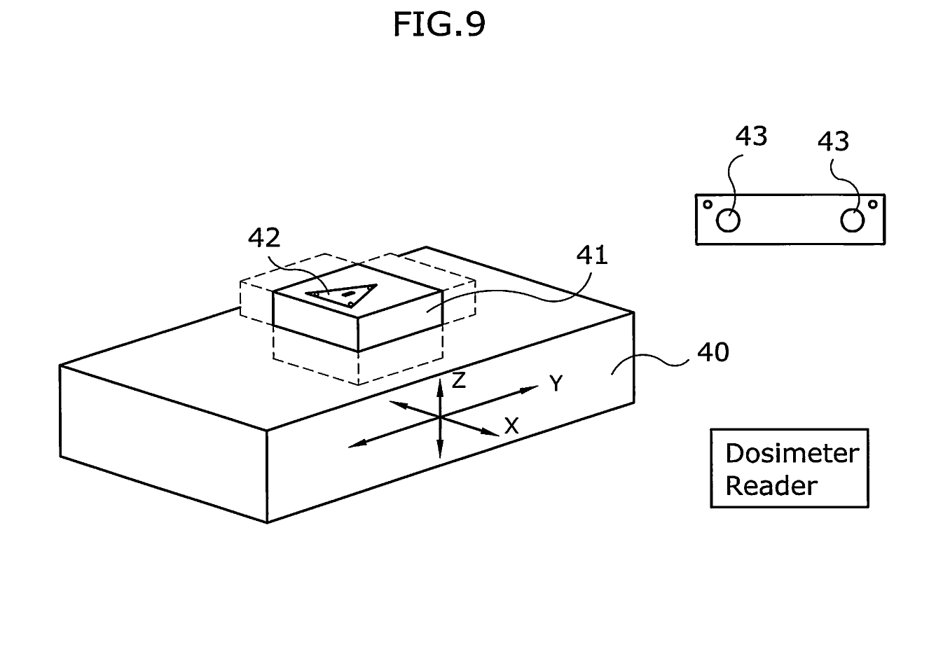

FIG. 9 illustrates the DosiLoc device setting on a phantom 40 to monitor simultaneously target dose and position in 3D motion. In the case of moving objects or phantoms, where the position determination is as important as the dose, it is desirable to have the DosiLoc device 42 taped on the surface of the moving object 41 and monitor simultaneously the position of the device using its optical markers by the camera 43 and the dose using a reader as described in FIG. 2 above. Such configuration is used to verify treatment plan deliveries for patients treated with moving tumors, such as Lung tumors, due to breathing or other motion.

One advantage of this configuration using optical markers is its immunity to electromagnetic interferences and metallic objects which could disturb the signal accuracy if electromagnetic positioning sensors are used alone. It is anticipated that the setting described in FIG. 7, combining optical and electromagnetic sensor tracking, can be used for optimal and real-time phantom motion monitoring in conditions where magnetic interferences and optical signal obstruction could be present; this system combination allows redundancy in position measurement using two independent systems.

The method according to a current aspect can be implemented as computer readable codes in a computer readable record medium. The computer readable record medium includes all types of record media in which computer readable data are stored. Examples of the computer readable record medium include a ROM, a RAM, a CD-ROM, a magnetic tape, a floppy disk, and an optical data storage. Further, the record medium may be implemented in the form of a carrier wave such as Internet transmission. In addition, the computer readable record medium may be distributed to computer systems over a network, in which computer readable codes may be stored and executed in a distributed manner.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

1. A DosiLoc apparatus for accurately measuring radiation beams during treatment which comprises:
a dosimeter which is used to measure the radiation;
an optical marker which is used to determine a patient's position; and
said dosimeter and said optical marker are connected to one another used to provide simultaneously a radiation dose reading and a measurement of patient's movement during treatment.

2. The DosiLoc apparatus of claim 1 for accurately measuring radiation beams during treatment, wherein said dosimeter is an IGFET, a MOSFET, a diode, a PIN-diode, a floating gate MOSFET, a dual-MOSFET, or a single MOSFET, a film, a TLD, OSL.

3. The DosiLoc apparatus of claim 1 for accurately measuring radiation beams during treatment, wherein said dosimeter and said optical marker can be set on a flexible or rigid substrate.

4. The DosiLoc apparatus of claim 1 for accurately measuring radiation beams during treatment, further comprising:
a support object that holds the optical marker which can be set to a flat or vertical position in relation to a surface of the patient or radiation beam.

5. The DosiLoc apparatus of claim 1 for accurately measuring radiation beams during treatment, wherein said optical marker and a cover are disposable for single use.

6. The DosiLoc apparatus of claim 1 for accurately measuring radiation beams during treatment, wherein said optical marker and a cover are reusable by a sterilization process.

7. The DosiLoc apparatus of claim 1 for accurately measuring radiation beams during treatment, wherein said optical markers can be used on a substrate with said dosimeter.

8. The DosiLoc apparatus of claim 1 for accurately measuring radiation beams during treatment, wherein a plurality of dosimeters and a plurality of optical markers are located on a single substrate in alternative order to create a matrix cell.

9. The DosiLoc apparatus of claim 1 for accurately measuring radiation beams during treatment, further comprising: said optical marker can be any spherical, cylindrical, flat, tetrahedral, cubic, or hollow shape.

10. The DosiLoc apparatus of claim 1 for accurately measuring radiation beams during treatment, wherein said optical marker can be of any reflective type comprising copper, gold aluminum, sliver, or any optical material with reflective properties.

11. The DosiLoc apparatus of claim 1 for accurately measuring radiation beams during treatment, wherein said optical marker varies in thickness to allow radio-opacity for optical localization from cameras and visibility from x-ray imaging devices simultaneously.

12. The DosiLoc apparatus of claim 1 for accurately measuring radiation beams during treatment, wherein said dosimeter attaches to a support means, which further comprises:
a connector connected to a dose reader; and
said dose reader can transmit wirelessly said radiation dose reading to a computer or through wired connection, while having said optical markers track motion using a plurality of cameras to transmit said measurement of the patient's movements to display both information on one or more display apparatuses.

13. The DosiLoc apparatus of claim 12 for accurately measuring radiation beams during treatment, wherein said support means can be attached by a permanent or a detachable connector to said dose reader.

14. The DosiLoc apparatus of claim 1 for accurately measuring radiation beams during treatment, further comprising:
said dosimeter monitors dose continuously while patient position is monitored at a fixed time interval, and conversely said optical marker monitors patient position continuously while dose is monitored at a fixed time interval.

15. The DosiLoc apparatus of claim 1 for accurately measuring radiation beams during treatment, further comprising:
said dosimeter monitors dose continuously while patient position is monitored at a fixed time interval, or conversely said optical marker monitors patient position continuously while dose is monitored at a fixed time interval.

16. The DosiLoc apparatus of claim 1 for accurately measuring radiation beams during treatment, wherein said radiation dose reading and said measurement of the patient's movements can be displayed on different display apparatus and in a combination of graphical or table format settings of dose and position parameters.

17. The DosiLoc apparatus of claim 12 for accurately measuring radiation beams during treatment, further comprising: said dose reader and said optical marker are wireless and dose measured by MOSFETs or floating gate MOSFETs, while the position is still monitored continuously with said optical marker.

18. The DosiLoc apparatus of claim 8 for accurately measuring radiation beams during treatment, further comprising: said dosimeter can be in an array configurations with said optical markers attached between dosimeters, allowing simultaneous localization and dose measurement in a given dosimetry session.

19. The DosiLoc apparatus of claim 18 for accurately measuring radiation beams during treatment, wherein said array configuration comprises a linear shape, a 2-D shape, or a 3-D shape at different depths.

20. The DosiLoc apparatus of claim 1 for accurately measuring radiation beams during treatment, further comprising: an array dosimeter are inserted in tubes or catheters, temporarily or permanently, and whereby said optical markers are attached to surface tube at preset locations in relation to said array dosimeters, allowing reflection and optical localization of the dosimeters.

21. The DosiLoc apparatus of claim 1 for accurately measuring radiation beams during treatment, wherein said dosimeter is covered with an optical marker of hemispherical shape to provide simultaneously build-up material configuration and dose measurement at different depths representative of a tumor location.

22. The DosiLoc apparatus of claim 21 for accurately measuring radiation beams during treatment, wherein said optical marker is composed of plastic composite that is a density close to water or a dense metallic material that reduces said DosiLoc size in high photon, electron or proton energy settings.

23. The DosiLoc apparatus of claim 1 for accurately measuring radiation beams during treatment, wherein said optical marker is used in combination with a magnetic sensor to allow absolute optical localization and accurate referencing of a magnetic based sensor.

24. The DosiLoc apparatus of claim 23 for accurately measuring radiation beams during treatment, wherein said optical marker is printed permanently on the magnetic sensor or attached temporarily as a cap on its surface with possible removal.

25. The DosiLoc apparatus of claim 1 for accurately measuring radiation beams during treatment, wherein said optical marker can be printed on the dosimeter itself or on its build-up cap.

26. The DosiLoc apparatus of claim 1 for accurately measuring radiation beams during treatment, wherein said dosimeter can be a TLD (thermoluminsecent) with said optical marker coating on one face while another side is not coated to allow for radiation dose reading.

27. The DosiLoc apparatus of claim 1 for accurately measuring radiation beams during treatment, wherein said dosimeter can be an OSL (optically stimulated luminescence) in a black container, coated with an optical marker.

28. The DosiLoc apparatus of claim 1 for accurately measuring radiation beams during treatment, wherein said optical marker can be a diode emitters with light constantly analyzed by cameras; and whereby said diode emitter being powered by a battery supply or by light through photocells integrated into said diode emitter to alleviate surface contamination issues in relation to passive markers.

29. The DosiLoc apparatus of claim 1 for accurately measuring radiation beams during treatment, wherein said optical marker is composed of fluorescent material for low light conditions.

30. The DosiLoc apparatus of claim 12 for accurately measuring radiation beams during treatment, wherein an optical marker position is used as a reference for other said optical markers, providing relative motion at a given location.

31. The DosiLoc apparatus of claim 12 for accurately measuring radiation beams during treatment, further comprising:
a phatom that is a plurality of block materials in substitute of a patient attached to said DosiLoc is used to monitor in real-time treatment delivery by said optical marker measuring movement that alleviates magnetic interferences issues relating to surrounding metallic objects and control systems.

32. The DosiLoc apparatus of claim 12 for accurately measuring radiation beams during treatment, further comprising:
said dosimeter is composed of a film that is attached to said optical marker that provides average position, patient shift and dose during radiotherapy procedures.

33. The DosiLoc apparatus of claim 12 for accurately measuring radiation beams during treatment, further comprising:
a plurality of DosiLoc devices are used, wherein, a single DosiLoc of the plurality of DosiLoc devices is used to provide position or dose reference point from said plurality of DosiLoc devices, whereby said plurality of DosiLoc devices provide a relative motion or dose determination when monitoring said plurality of DosiLoc devices.

34. The DosiLoc apparatus of claim 31 for accurately measuring radiation beams during treatment, further comprising:
said DosiLoc is used in combination with a magnetic sensor that is used to monitor and determine in real-time movement of said phantom and the dose delivered to known locations during treatment delivery which alleviates electromagnetic interference encountered by said magnetic sensors due to metallic objects and control system electronics.

35. The DosiLoc apparatus of claim 12 for accurately measuring radiation beams during treatment, further comprising:
said DosiLoc is composed of a film that is attached on or around the surface of said optical marker.

36. A method of reading a DosiLoc device which comprises:
reading a dosimeter to determine an amount of dose;
tracking an optical marker to determine an amount of change in position;
monitoring a preset limits that are set in a software response to position measurement; and
altering when a patient shift is beyond a certain threshold that results in stopping a radiation beam.

37. The method of claim 36 wherein reading the DosiLoc device which comprises:
synchronizing said radiation beam to a breathing pattern of said patient; and
altering a medical personnel when a dose or position exceeds said preset limit from a treatment plan.
